(19) United States
(12) Patent Application Publication
(10) Pub. No.: US 2014/0312216 A1
(43) Pub. Date: Oct. 23, 2014

(54) SIGNAL PROCESSING FOR MASS DIRECTED FRACTION COLLECTION

(71) Applicant: ADVION INC., Ithaca, NY (US)

(72) Inventors: Simon Prosser, Ithaca, NY (US); Ben Trumbore, Ithaca, NY (US); Sha Wang, Ithaca, NY (US); Nigel Sousou, Liverpool, NY (US)

(73) Assignee: Advion Inc.

(21) Appl. No.: 13/864,606

(22) Filed: Apr. 17, 2013

(51) Int. Cl. H01J 49/00; H01J 49/02

(52) U.S. Cl. CPC H01J 49/0036; H01J 49/022
USPC 250/282; 250/288

(57) ABSTRACT

A system and removing noise from a mass spectrometer signal for fraction collection is described herein.

### BACKGROUND

Liquid chromatography (LC) is a chromatographic technique used to physically separate mixtures of compounds in many areas of research including synthetic organic chemistry and biochemistry. Liquid chromatography can be used to isolate, purify, identify and quantify individual components. These components can be measured on line by a variety of detectors, such as UV and Mass Spectrometers, and can be also be isolated and collected by fraction collection devices that are triggered by the detector. There are different types of liquid chromatography that are used depending on the properties of the sample that is being separated, and a wide range of flow rates that are encompassed, depending on the quantity of compound to be separated. These chromatographic techniques include reverse phase liquid chromatography (often called HPLC, UHPLC or prep-LC), normal phase flash chromatography (NPFC) and supercritical fluid chromatography (SFC).

### SUMMARY

A system and removing noise from a mass spectrometer signal for fraction collection of LC eluent is described herein.

In some aspects, a method of performing fraction collection, the method comprising delivering an eluent containing a substance of interest from a liquid chromatography system, directing the eluent through a splitter device to cause a first portion of the eluent to be directed to a mass spectrometer and a second portion of the eluent to be directed to a collection device, analyzing the eluent using the mass spectrometer to obtain a raw signal, processing the raw signal in real time to generate a processed signal prior to the eluent corresponding to the processed signal reaching the collection device, the processed signal removing at least some noise from the raw signal, and selecting portions of the eluent to collect by the collection device based on the processed signal.

Embodiments can include one or more of the following.

Processing the raw signal to generate a processed signal can include during a first time period, calculating a baseline signal based on the raw signal and during time periods after the first time period, subtracting the baseline signal from the raw signal to generate the processed signal.

Processing the raw signal to generate a processed signal can include applying a triangle filter to the raw signal to generate the processed signal.

Processing the raw signal to generate a processed signal can include applying a box filter to the raw signal to generate the processed signal.

Processing the raw signal to generate a processed signal can include applying a Gaussian filter to the raw signal to generate the processed signal.

Processing the raw signal to generate a processed signal can include applying a Savitzky Golay filter to the raw signal to generate the processed signal.

The method can also include providing the processed signal to the fraction collection device.

Providing the processed signal to the fraction collection device can include providing the processed signal to the fraction collection device within 5 seconds of generating the raw signal.

Providing the processed signal to the fraction collection device can include providing the processed signal to the fraction collection device within 10 seconds of generating the raw signal.

Processing the raw signal to generate a processed signal can include processing the raw signal in real time.

Processing the raw signal to generate a processed signal can include concurrently processing portions of the raw signal while the mass spectrometer is collecting later portions of the raw signal.

### DESCRIPTION OF THE DRAWINGS

FIGS. 1A and 1B show exemplary material purification systems.

FIG. 2 shows an exemplary signal before and after filtering.

FIG. 3 is a flow chart of an exemplary process for filtering a baseline signal from a collected mass spec signal.

FIG. 4 is a flow chart of an exemplary process for filtering a signal collected by mass spectrometer in near real time.

Like reference symbols in the various drawings indicate like elements.

### DESCRIPTION

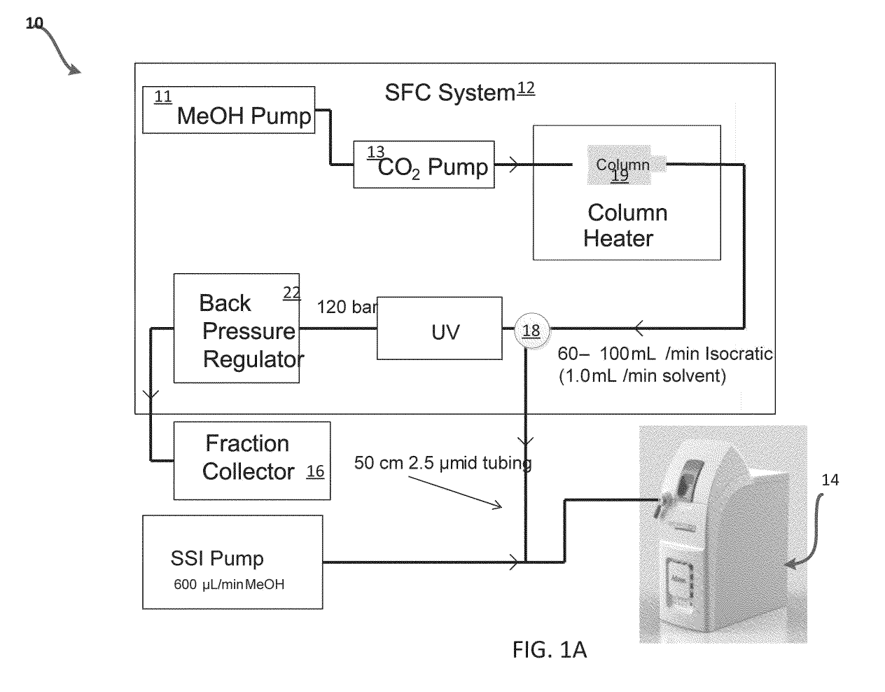

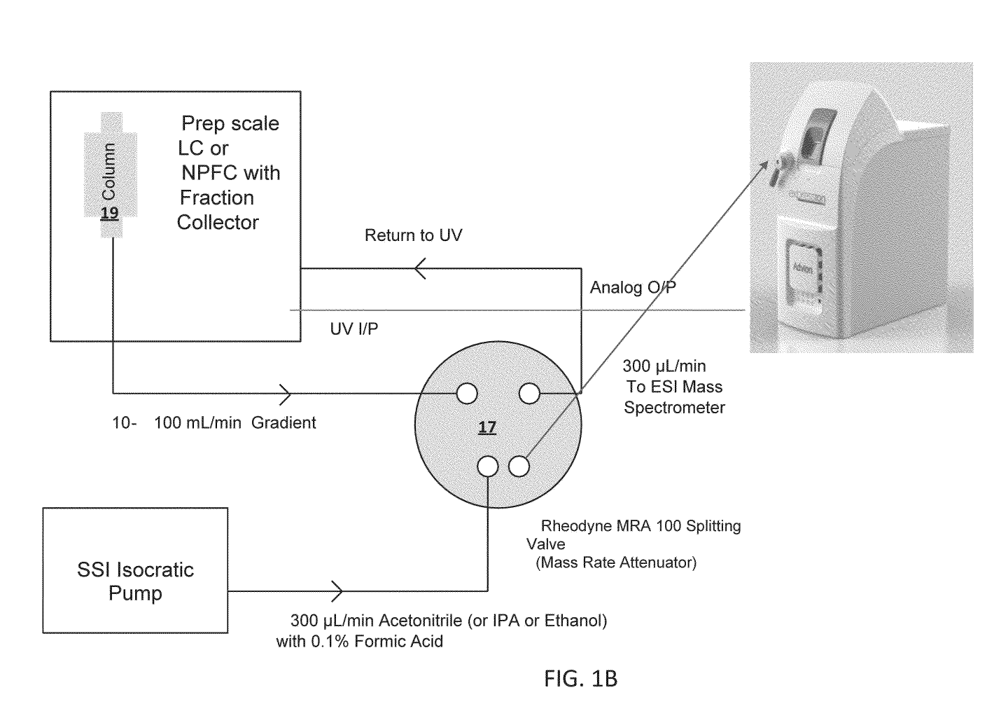

FIG. 1A shows a system 10 for liquid chromatography-mass spectrometry (LC/MS) with simultaneous fraction collection. LC/MS is a technique that combines the physical separation capabilities of liquid chromatography with the mass analysis capabilities of mass spectrometry (e.g., based on a signal measured by a mass spectrometer 14). System 10 can be used for mass directed purification of products. In system 10, LC/MS is combined with simultaneous fraction collection by a fraction collection device 16. The fraction collection device 16 collects different chromatographically separated materials (e.g., fractions) into separate receptacles. Such a combination of LC/MS with simultaneous fraction collection can be used, for example, in areas such as synthetic organic chemistry for the purification of novel chemical entities, active pharmaceutical ingredients, biologics, intermediates and final products, isolation and identification of impurities, purification of natural products, metabolite identification, biomarker analysis, and/or protein characterization.

When system 10 is used in a liquid chromatography/mass spectrometry (LC/MS) fraction collection mode, an LC system 12 (in this example an SFC system) is coupled to a fraction collection device 16, which interfaces with a mass spectrometer 14 that performs spectral analysis. In use, an effluent provided by the LC system 12 is directed through a column 19 using a methanol pump 11 and a carbon dioxide pump 13. The column 19 retains individual components by the stationary phase differently and separates the different components from each other while they are running at different speeds through the column with the eluent. At the end of the column 19 they elute one at a time (e.g., the analytes of interest enter the fraction collection device 16 one at a time). More particularly, components of the sample move through the column 19 at different velocities, which are function of specific physical interactions with the sorbent (also called stationary phase). The velocity of each component depends on its chemical nature, on the nature of the stationary phase (column) and on the composition of the mobile phase. The time at which a specific analyte elutes (emerges from the column) is called its retention time. Thus, by using a chromatography process the eluent is directed from the column 19 in a series of fractions.

The composition of the eluent flow is monitored using the mass spectrometer 14, which analyzes each fraction for dissolved compounds. In order to collect the desired fractions, the eluent is split post column 19 by a splitter device 18 such that a portion is directed to an interface to the mass spectrometer 14 while the remainder of the split eluent is collected at time segments into collection devices in the fraction collector such as flasks, tubes, multi-well plates. The splitting device may be a simple passive split where the split ratio is defined by the resistance to flow on either side of a ‘T’, or it might be an active splitting device such as a repetive switching valve (e.g., valve 17 shown in FIG. 1B). The length of the liquid flow path between the splitter 18 and a device which deposits the fractions into the collection receptacles is longer than a length of the flow path to the mass spectrometer 14. The difference in time required for the eluent to travel along the different path lengths allows time for the mass spectrometer 14 to collect and process a signal in time to direct the fraction collection device 16 to collect the desired fractions. Thus, a user or researcher is able to select and collect fractions of interest by determining when the fractions of interest are coming off the column 19 using data from the mass spectrometer 14 and directing the fraction collection device 16 to collect the fraction of interest at the appropriate time. Thus, as the eluent is being delivered to the mass spectrometer 14, a processed signal is continually sent to the fraction collection device with minimal delay (e.g., the signal is processed in real time rather than waiting for the mass spectrometer to complete the measurements prior to processing).

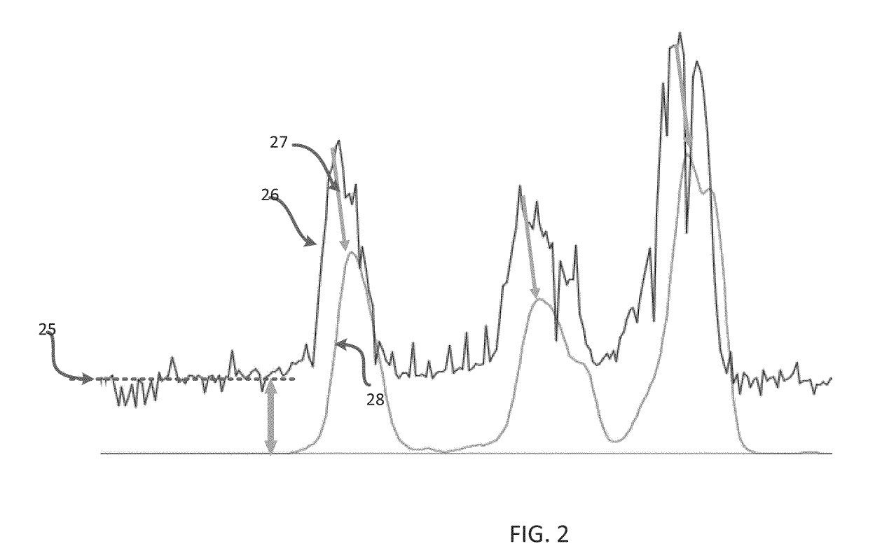

In system 10, the mass spectrometer 14 generates a signal and sends the signal to the fraction collection device 16. The fraction collection device 16 uses the received signal in order to identify when the fraction of interest should be collected. Thus, by identifying a peak in the signal from the mass spectrometer 14, the fraction collection device 16 can determine when to collect the fraction of interest. More particularly, the fraction collection device 16 can divert the liquid into a collection container upon identifying the rising edge of the signal from the mass spectrometer and can stop diverting the liquid into the collection container upon identifying the falling edge of the signal from the mass spectrometer (e.g., the liquid can then be diverted to a waste container or other collection device). As shown in FIG. 2, a signal 26 obtained by the mass spectrometer 14 can include noise, which can interfere with the ability of the fraction collection device 16 to accurately identify the rising and falling edges of the signal. Additionally, in some examples, the signal obtained by the mass spectrometer can include a baseline signal generated by chemical noise (e.g., as indicated by dashed line 25), which can cause the fraction collection device to inaccurately trigger collection. For example, if the fraction collection device triggers collection based on a threshold, if the baseline signal is high enough a small rise in the signal can trigger collection even if the signal rise is not indicative of a peak, based on observation of the desired component.

The systems and methods described herein include software and processes for removing noise from the signal generated by the mass spectrometer 14 in real time, such that a processed signal 28 can be sent to the fraction collection device 16 and used to determine when to collect the desired sample. In some examples, the processed signal can be slightly delayed as compared to the signal generated by the mass spectrometer as indicated by arrow 27. For example, the filtered signal can be delayed by less than 10 seconds (e.g., less than 10 seconds, less than 8 seconds, less than 5 seconds, less than 4 seconds) from the acquisition time of the signal by the mass spectrometer. As such, the signal is received by the fraction device within 10 seconds (e.g., within 10 seconds, within 8 seconds within 5 seconds, within 4 seconds) from the measurement of the unprocessed/raw signal by the mass spectrometer. Thus, while filtering the signal does introduce a small amount of delay in providing the signal to the fraction collection device 16, this delay does not hamper collection of the desired fraction because the fluid path between the splitter 18 and the collection receptacle is designed to introduce a longer delay between the splitter and the output than the amount of time used to process the signal collected by the mass spectrometer 14. Triggering based on the processed signal 28, rather than the originally collected signal 26 can provide the benefit of improving the recovery rate for purification because the system can start and stop collection more accurately.

In the example shown in FIG. 2, two types of processing are used to generate the processed output signal 28 from the signal collected from the mass spectrometer 20. First, baseline noise (e.g., indicated by dashed line 25) is removed. Removal of the baseline signal 25 shifts the processed signal 28 down by an amount that is based on the average signal observed during a time expected to include only noise. Thus, removal of the baseline signal 25 effectively results in an auto-zeroing of the processed signal 28. Removing the baseline signal when generating the processed signal 28 can aid in accurate triggering of the fraction collection device because the processed signal will not be higher than expected value due to a large baseline signal. A second type of processing used to generate processed signal 28 includes signal smoothing or filtering. The signal smoothing operates over time and applies a filter to generate a smoothed value from the collected mass spectrometer signal. Exemplary filters which can be used to filter the signal collected by the mass spectrometer 14 can include triangle filters, Gaussian filters, box car filters, Savitzky Golay filters. In another example averaging of signals over a particular time can be used to generate the values for the smoothed signal. Additionally, based on the amount of desired smoothing, a smoothing time span can be specified by a user. The smoothing time sets a length of time used to select the data from the mass spectrometer that will be used to calculate the smoothed value. For example, a smoothing time of 4 seconds will utilize 4 seconds of data around the desired time to calculate the processed value. Thus, the smoothing time sets a moving window used to select the data. Exemplary smoothing time spans can be from about 1 second to about 10 seconds.

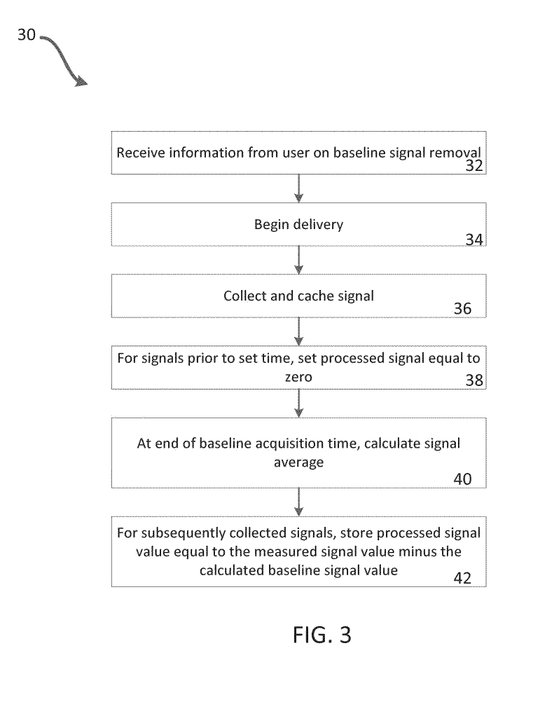

Referring to FIG. 3, a process 30 for removing a baseline signal from a raw (e.g., an unprocessed) signal measured by the mass spectrometer 14 is shown. The user provides an input specifying that optional processing of baseline signal removal is to be applied to a selected analog output signal (32). The user also specifies time window during acquisition over which signal is averaged to determine the baseline value. The time window is selected to be a period of time after the mass spectrometer begins collecting signal but prior to any expected peaks. Thus, the time window selected is intended to include a signal made up of only noise within the measurements made by the mass spectrometer.

The LC system 12 begins delivery of the fluid through the splitter 18 and a portion of the fluid is directed to the mass spectrometer 14 (34). When the mass spectrometer begins measuring a signal, an internal clock can be initialized to track the timing for the received time window. The mass spectrometer 14 collects and caches the mass spectrometry signal (36). For each scan of the acquisition, a raw analog output signal value is calculated from the TIC or XIC specification, as requested by the user. The total ion current (TIC) chromatogram represents the summed intensity across the entire range of masses being detected at every point in the analysis. In an extracted ion chromatogram (XIC or EIC), one or more m/z values representing one or more analytes of interest are recovered (‘extracted’) from the entire data set. The TIC or XIC signal includes any noise that is measured by the mass spectrometer 14. To generate the processed signal, the mass spectrometer 14 sets the processed signal equal to zero for times prior to the end of the time window used for baseline determination (38). When the mass spectrometer has collected the mass spectrometry signal for the entire time of the user-defined baseline collection time window, the mass spectrometry system 14 calculates a baseline signal (40). The baseline signal can be calculated as the average of the signal values during the user-defined time window. For signals collected subsequent to the end of the user-defined time window, the system calculates a value for the processed signal value by subtracting the baseline signal value from the measured signal value (42). Thus, by subtracting the baseline signal value the entire processed signal curve is shifted to remove/zero out the contribution of the baseline signal.

Based on the process 30 above, the processed signal includes three portions. In a first portion which includes retention times before the specified baseline calculation start time, the processed signal is set to zero. For a second portion which includes retention times after the specified baseline calculation start time, all cached values having retention times within the specified window are averaged to determine the baseline value. The value for the processed signal during this time period is also set to zero. The third portion which includes retention times after the specified baseline calculation time, the processed signal equals the raw/measured signal minus the calculated baseline value. If the result is negative, the processed signal is set to zero.

In some examples, the same compound is repeatedly purified. In such examples, the timing of multiple, different peaks that are observed as the eluent is delivered from the column 19 could be generally known. In such cases, because the baseline signal can drift or vary over time, a new baseline signal can be calculated and subtracted from the acquired signal multiple different times. For example, at time between adjacent peaks, the baseline can be recalculated such that a new baseline signal would be subtracted from the acquired signal.

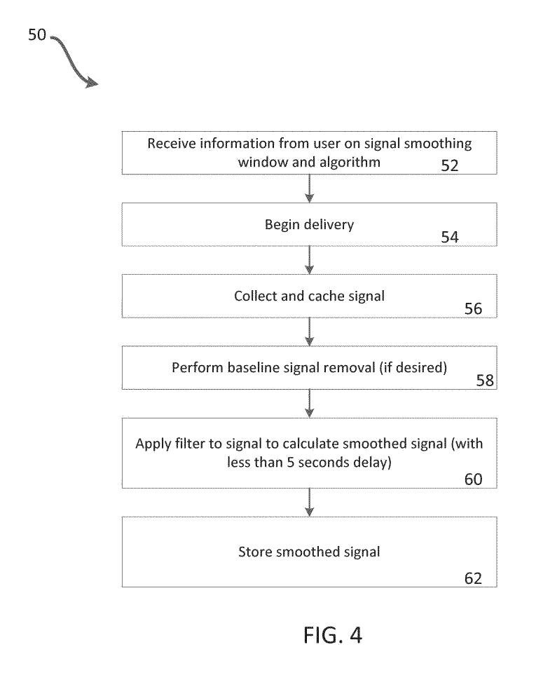

FIG. 4 shows a process 50 for generating a smoothed signal from a signal acquired by the mass spectrometer 14. Process 50 includes receiving information from a user about a signal smoothing window and type of filter to be used in the smoothing. The signal smoothing window specifies time span during acquisition over which signal values are filtered to generate smoothed signal value. For example, if a value of 4 seconds is input as the signal smoothing window, the analog signals for 4 seconds of acquired data are input into a filter or other calculation to generate the smoothed output. In this example, the calculated smoothed value for a particular time would be based on 2 seconds of data acquired prior to that time and 2 seconds of data acquired after that time.

The LC system 12 begins delivery of the fluid through the splitter 18 and a portion is directed to the mass spectrometer 14 (54). When the mass spectrometer begins measuring a signal, an internal clock can be initialized to track the timing for the signal smoothing. The mass spectrometer 14 collects and caches the mass spectrometry signal (56). For each scan of the acquisition, a raw analog output signal value is calculated from the TIC or XIC specification, as requested by the user, and cached. The total ion current (TIC) chromatogram represents the summed intensity across the entire range of masses being detected at every point in the analysis. In an extracted ion chromatogram (XIC or EIC), one or more m/z values representing one or more analytes of interest are recovered (‘extracted’) from the entire data set. The TIC or XIC signal includes any noise that is measured by the mass spectrometer 14.

After acquiring the TIC or XIC signal, the mass spectrometer 14 processes the signal to remove a baseline signal if desired (58). For example, the baseline signal can be removed using a process such as the process described above in relation to FIG. 3. After removing the baseline signal (if desired), the system applies a filter to generate a smoothed signal (60) and cache the smoothed signal (62). The smoothed signal is delayed by a short period of time from the time the raw data signal was collected by the mass spectrometer. For example, the calculation of the smooth signal can delay the signal by less than 10 seconds (e.g., less than 10 seconds, less than 8 seconds, less than 5 seconds, less than 3 seconds). Thus, in effect, the signal smoothing occurs in real time and a smoothed signal can be provided to the fraction collection device 16 prior to the liquid which was analyzed reaching the collection receptacle. As such, the smoothed signal can be sent to the fraction collection device 16 in near real-time, such that collection decisions by the fraction collection device 16 can be based on the smoothed data rather than the raw data collected by the mass spectrometer 14.

In one particular example, for each scan with a retention time before a specified smoothing time span, a smoothed value of zero is cached. For the first scan with retention time after the specified smoothing time span, the number of completed scans is noted and rounded down to the next odd integer. This is the filter width, or number of samples to be used when performing filtering. For each scan with a retention time after the specified smoothing time span (having scan index num), a Triangular Filter is applied over the previous width samples. This produces a smoothed signal value corresponding to scan index num-(width−1)/2. This value is cached for scan index num, effectively producing a signal delay of roughly half the requested smoothing time span. The appropriate cached value (processed or smoothed) is assigned to the electronics which produce an output voltage corresponding to the assigned value.

In the example above a triangle filter was used to generate the smoothed signal, however, other filters can be used. For example, a boxcar filter, simple averaging, a Gaussian filter, or a Savitzky Golay filter could be used. In general, the processed signal is produced in close to real time. For example, the processed signal is produced and provided to the fraction collection device with a signal delay of approximately half of the smoothing timespan.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory program carrier for execution by, or to control the operation of, data processing apparatus. The computer storage medium can be a machine-readable storage device, a machine-readable storage substrate, a random or serial access memory device, or a combination of one or more of them.

The term “data processing apparatus” refers to data processing hardware and encompasses all kinds of apparatus, devices, and machines for processing data, including by way of example a programmable processor, a computer, or multiple processors or computers. The apparatus can also be or further include special purpose logic circuitry, e.g., an FPGA (field programmable gate array) or an ASIC (application-specific integrated circuit). The apparatus can also optionally include, in addition to hardware, code that creates an execution environment for the computer programs in question, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Computers suitable for the execution of a computer program include, by way of example, can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

Although a few implementations have been described in detail above, other modifications are possible. In addition, the logic flows depicted in the figures do not require the particular order shown, or sequential order, to achieve desirable results. Other steps may be provided, or steps may be eliminated, from the described flows, and other components may be added to, or removed from, the described systems. Accordingly, other implementations are within the scope of the following claims.

1. A system for performing fraction collection, the system comprising:
a fluid delivery device configured to deliver an eluent containing a substance of interest from a liquid chromatography system;
a splitter device configured to cause a first portion of the eluent to be directed to a mass spectrometer and a second portion of the eluent to be directed to a collection device;
a processor configured to:
analyze the eluent using the mass spectrometer to obtain a raw signal;
calculate a baseline signal based on the raw signal acquired during a time window subsequent to signal collection and prior to an expected signal peak,
process the raw signal in real time to generate a processed signal prior to the eluent corresponding to the processed signal reaching the collection device, the processed signal removing at least some noise from the raw signal including subtracting the baseline signal from the raw signal; and
select portions of the eluent to collect by the collection device based on the processed signal.

2. The system of claim 1, further comprising configurations to:
recalculate a new baseline signal based on the raw signal acquired during a time window between adjacent signal peaks; and
subsequent to recalculating the new baseline signal, subtract the new baseline signal from the raw signal to generate the processed signal.

3. The system of claim 1, the configurations to process the raw signal to generate a processed signal comprise configurations to apply a triangle filter to the raw signal to generate the processed signal.

4. The system of claim 1, wherein the configurations to process the raw signal to generate a processed signal comprise configurations to apply a box filter to the raw signal to generate the processed signal.

5. The system of claim 1, wherein the configurations to process the raw signal to generate a processed signal comprise configurations to apply a Gaussian filter to the raw signal to generate the processed signal.

6. The system of claim 1, wherein the configurations to process the signal to generate a processed signal comprise configurations to apply a Savitzky Golay filter to the raw signal to generate the processed signal.

7. The system of claim 1, further comprising configurations to provide the processed signal to the fraction collection device.

8. The system of claim 7, wherein configurations to provide the processed signal to the fraction collection device comprises providing the processed signal to the fraction collection device within 5 seconds of generating the raw signal.

9. The method of claim 1, wherein the configurations to process the raw signal to generate a processed signal comprise configurations to concurrently process portions of the raw signal while the mass spectrometer is collecting later portions of the raw signal.

10. A method of performing fraction collection, the method comprising:
delivering an eluent containing a substance of interest from a liquid chromatography system;
directing the eluent through a splitter device to cause a first portion of the eluent to be directed to a mass spectrometer and a second portion of the eluent to be directed to a collection device;
analyzing the eluent using the mass spectrometer to obtain a raw signal;
calculating a baseline signal based on the raw signal acquired during a time window subsequent to signal collection and prior to an expected signal peak,
processing the raw signal in real time to generate a processed signal prior to the eluent corresponding to the processed signal reaching the collection device, the processed signal removing at least some noise from the raw signal including subtracting the baseline signal from the raw signal; and
selecting portions of the eluent to collect by the collection device based on the processed signal.

11. The method of claim 10, further comprising:
recalculating a new baseline signal based on the raw signal acquired during a time window between adjacent signal peaks; and
subsequent to recalculating the new baseline signal, subtracting the new baseline signal from the raw signal to generate the processed signal.

12. The method of claim 10, wherein processing the raw signal to generate a processed signal comprises applying a triangle filter to the raw signal to generate the processed signal.

13. The method of claim 10, wherein processing the raw signal to generate a processed signal comprises applying a box filter to the raw signal to generate the processed signal.

14. The method of claim 10, wherein processing the raw signal to generate a processed signal comprises applying a Gaussian filter to the raw signal to generate the processed signal.

15. The method of claim 10, wherein processing the raw signal to generate a processed signal comprises applying a Savitzky Golay filter to the raw signal to generate the processed signal.

16. The method of claim 10, further comprising providing the processed signal to the fraction collection device.

17. The method of claim 16, wherein providing the processed signal to the fraction collection device comprises providing the processed signal to the fraction collection device within 5 seconds of generating the raw signal.

18. The method of claim 16, wherein providing the processed signal to the fraction collection device comprises providing the processed signal to the fraction collection device within 10 seconds of generating the raw signal.

19. The method of claim 10, wherein processing the raw signal to generate a processed signal comprises processing the raw signal in real time.

20. The method of claim 10, wherein processing the raw signal to generate a processed signal comprises concurrently processing portions of the raw signal while the mass spectrometer is collecting later portions of the raw signal.
